(19) United States
(12) Patent Application Publication
(10) Pub. No.: US 2019/0379036 A1
(43) Pub. Date: Dec. 12, 2019

(54) METHOD FOR PREPARING BATTERY PLATES

(71) Applicant: ADVANCED BATTERY CONCEPTS, LLC, Clare, MI (US)

(72) Inventor: Adam Cadena, Auburn, MI (US)

(21) Appl. No.: 16/437,829

(22) Filed: Jun. 11, 2019

Related U.S. Application Data
(60) Provisional application No. 62/683,897, filed on Jun. 12, 2018.

(51) Int. Cl. H01M 4/139; H01M 4/04

(52) U.S. Cl. CPC H01M 4/139; H01M 4/0471; H01M 4/0404

(57) ABSTRACT

A method for producing a battery plate including: a) adhering a current collector to one or more surfaces of a substrate of the battery plate; b) ablating a pasting surface of the current collector with a non-contact energy source; c) pasting the current collector with an active material; and d) curing and drying the active material on the current collector to form an electrode as part of the battery plate.

### FIELD

The present teachings generally relate to a method of preparing a battery plate, such as one or more battery plates useful within a bipolar battery assembly. The method may be particularly advantageous in removing oxidation and contaminants of a current collector to improve adhesion of an active material onto the current collector.

### BACKGROUND

Bipolar battery assemblies, such as that taught in U.S. Pat. Nos. 8,357,469; 9,553,329; 9,825,336; and U.S. patent application Ser. No. 15/802,797, incorporated herein in their entirety by reference, include an electrolyte within a stack of battery plates. The battery plates have active material thereon which faces toward active material of an adjacent battery plate in the stack. To create an electrochemical cell, a negative active material of one battery plate, which may be referred to as the anode, faces a positive active material of an adjacent battery plate, which may be referred to as the cathode. The electrolyte is located within the electrochemical cells and allows electrons and ions to flow between the cathode and anode of the battery plates. Typically, within each electrochemical cell is also a separator. The active material may be applied in paste form onto the battery plates as taught in U.S. Pat. No. 9,553,329 and PCT Application No. PCT/US2010/021480, incorporated by reference in their entirety for all purposes. Each battery plate usually includes a substrate and a metal current collector may be disposed on the substrate.

Typical metal current collectors include a metal foil or a metal grid. The current collectors generally function to disperse electrons flowing in the electrochemical cell, ensuring a connection of the active material to substrate, and even collecting the electrons and guiding the current flow to a current conduit, conductor, and/or terminal of the battery assembly. As the current collectors are formed of electrically conductive material, contact between the current collector and the active material forms the electrical connection between the two components to form a completed electrode. Between the time a current conductor is manufactured to the time the active material is applied thereon, the material of the current conductor may oxidize, collect contaminants such as dust and oils on a surface, or both. Oxidation and contaminants both reduce the adhesion strength between the active material and the current collector. One known method of removing the oxidation is wiring brushing. While wire brushing can be effective at removing oxidation and contaminants from a current collector, it can be time-consuming to remove a sufficient amount of the oxidation to expose a sufficient amount of the elemental metal of the current collector. One technique of wire brushing the conductor is passing the conductor under a plurality of wire brushes. One challenge is that it has been found that even multiple passes of a current conductor through a wire brushing process still expose less than 10% of the elemental metal at the brushed surface. Another downside of the typical wire brushing process is that particles removed from the current collector generate a dust which needs to be thoroughly cleaned before applying the active material thereon.

What is needed is a means of removing oxidation and other contaminants from a current collector to expose the elemental metal at the treated surface. What is needed is a means to remove oxidation and contaminants from a current collector at a rate which allows for mass production and commercialization. What is needed is a means which is not only suitable for removing oxidation and contaminants from a current collector, but produces minimal particle dust during removal. What is needed is a means which can not only be used to remove material from a current collector, but also create one or more patterns in the current collector.

### SUMMARY

The present disclosure relates to a method for producing a battery plate comprising: a) adhering a current collector to one or more surfaces of a substrate of the battery plate; b) ablating a pasting surface of the current collector with a non-contact energy source; c) pasting the current collector with an active material; and d) curing and drying the active material on the current collector to form an electrode as part of the battery plate.

The method for producing a battery plate may include one or more of the following features in any combination: the current collector may be comprised of one or more metals; the one or more metals may include: silver, tin, copper, aluminum, lead, alloys thereof, the like, or any combination thereof; the one or more metals may be lead or a lead alloy; the current collector may be in the form of a sheet, foil, grid, screen, mesh, the like, or any combination thereof; the energy source may utilize energy in the form of laser, infrared energy, microwave energy, radiofrequency, plasma, the like, or any combination thereof; the energy source may be in the form of one or more lasers which perform the ablating with a pulsed laser, a continuous wave laser, or both; the adhering step may occur before or after the ablating step; the pasting step may occur before or after the adhering step; the pasting surface may be opposite a substrate surface, and the substrate surface may face and be in contact with the substrate; the ablating may remove about 1 micron or greater of material on the pasting surface; the ablating may remove about 3 microns or greater to about 50 microns or less of material on the pasting surface; the ablating may remove about 0.05% or greater to about 30% or less of an overall thickness of the current collector before the ablating; the active material may be a positive active material or a negative active material; the active material may be a positive active material, and the current collector with the positive active material may form a cathode; the active material may be a negative active material, and the current collector with the negative active material may form an anode; the ablating step may leave one or more patterns on the pasting surface, a substrate surface opposite the pasting surface, or both of the current collector; the one or more patterns may include one or more identifiers; the one or more identifiers may include one or more part numbers, corporate identifiers, manufacturing sequence identifiers, or a combination thereof.

The present disclosure further relates to one or more battery plates, one or more battery assemblies, or both in which the battery plates are prepared according to the teachings herein.

The present teachings herein are useful in providing a method of ablating a current collector to remove oxidation and contaminants from a current collector. The ablating may allow for exposure of more than 10% of the elemental material of the current collector. The ablating may be formed with a non-contact energy source which may allow for mass production and commercialization. A non-contact energy source may utilize energy in the form of a laser to remove material from a current collector. A non-contact energy source to may be useful is exposing a sufficient amount of elemental material while avoiding a significant amount of dust and clean-up as compared to brushing or other mechanical means of material removal. The non-contact energy source may also be advantageous in also creating one or more patterns in a current collector, such as one or more pieces of identification information, assembly instructions, or both.

### BRIEF DESCRIPTION OF DRAWINGS

FIG. 1 illustrates an exploded view of a battery plate according to the teachings herein.

FIG. 2 illustrates a substrate and a current collector according to the teachings herein.

FIG. 3 illustrates a battery plate according to the teachings herein.

FIG. 4 illustrates the use of a laser for preparing a current collector according to the teachings herein.

FIG. 5 illustrates a chart comparing the percentage of elemental metal present on a surface of a current collector based on the method of preparation according to the teachings herein.

FIG. 6 illustrates a partially exploded view of a battery assembly according to the teachings herein.

FIG. 7 illustrates a perspective view of a battery assembly according to the teachings herein.

FIG. 8 illustrates a cross-sectional view of a battery assembly according to the teachings herein.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Method of Preparing Battery Plate

The present teachings relate to a method for producing a battery plate. The method may provide a method of improving adhesion of an active material to a current collector of a battery plate. The method may be particularly useful in promoting adhesion of an active material in paste form to the exposed elemental metal surface of a current collector. The method may comprise: a) adhering a current collector to one or more surfaces of a substrate of the battery plate; b) ablating a pasting surface of the current collector with a non-contact energy source; c) pasting the current collector with an active material; and d) curing and drying the active material on the current collector to form an electrode as part of the battery plate.

The method includes adhering a current collector to one or more surfaces of substrate. Adhering a current collector to a substrate may allow for the current collector to maintain an electrical connection with an active material, maintain the location of an active material on a substrate both during assembly and repetitive operation of a battery assembly, or both. Adhering a current collector to a substrate may include any method suitable for adhering the current collector affixed to the substrate during assembly, operation, or both of the battery assembly. Adhering a current collector to a substrate may include welding, adhesive bonding, the like, or any combination thereof. Adhering a current collector to a substrate may include applying one or more joining methods including but not limited to adhesives, solder, or melt bonding. Adhesives may be applied to a surface of a substrate, a surface of a current collector, or both. The one or more adhesives may be applied through one or more of spraying, brushing, extruding, roll coating, printing, the like, or any combination thereof. For example, one or more adhesives may be sprayed or extruded through one or more nozzles connected to a supply of the adhesive. Adhering a current collector to a substrate may include or be free of allowing an adhesive to become tacky before locating a current collector on a substrate. Allowing the adhesive to become tacky to the touch may allow for the current collector to remain in place relative to the substrate once located thereon, while the adhesive is not yet dry or cured. The adhesive may be allowed to precure before locating a current collector onto a substrate. Precuring may occur at one or more temperatures. Adhering a current collector to a substrate may include removal of a film. The adhesive may have a film located thereon. The film may be removed from the adhesive. Removal of the adhesive may expose the adhesive. The film may function to protect a tacky surface of the adhesive. The film may protect the adhesive from collecting contaminants. The film may allow for storage of a plurality of substrates, current collectors, or both with the adhesive applied thereon before adhering to a current collector or substrate.

The method includes ablating a pasting surface of a current collector. Ablating a pasting surface of a current collector may allow for exposure of a greater amount of elemental material of the current collector, increase one or more surface areas of a current collector, promote adhesion between a current collector and an active material, promote better flow of electrons between a current collector and active material, improve efficiency of a battery assembly, allow for identification information to be placed on a current collector, or any combination thereof. Ablating of a current collector may be performed before and/or after adhering a current collector to a substrate, applying adhesive to the current collector, or a combination thereof. Ablating may be any suitable method for removing oxidation, contaminants, elemental material, the like, or a combination thereof from a current collector. Ablating may be any suitable method for including identification information on a current collector. Ablating may include vaporization, chipping, other erosive processes, or a combination thereof. Ablating may be performed by one or more energy sources. The energy transmitted by the energy source may remove material from one or more surfaces of one or more current collectors. The material may be separate from the elemental material, include the elemental material, or both. One or more surfaces may include a pasting surface, substrate surface, or both. Removal of material from a pasting surface may promote adhesion and a stronger bond between the active material and a current collector. Material may include oxidation of a current collector, contaminants resting on a surface of a current collector, elemental material of the current collector, or any combination thereof. Ablation may remove about 0.5 microns or greater, about 0.75 microns or greater, about 1 micron or greater, about 3 microns or greater, or even about 5 microns or greater of material from a surface of a current collector. Ablation may remove about 100 microns or less, about 75 microns or less, or even about 50 microns or less of material from a surface of a current collector. For example, ablation may remove about 3 microns or greater to about 50 microns or less of material from a pasting surface of a current collector. Ablation may remove about 0.05% or greater, about 0.1% or greater, about 0.3% or greater, or even about 0.5% or greater of an overall thickness of a current collector. Ablation may remove about 75% or less, about 50% or less, about 40% or less, or even about 30% or less of an overall thickness of a current collector. For example, ablation may remove about 0.05% or greater to about 30% or less of an overall thickness of a current collector by removing material from the pasting surface. As another example, ablation may remove about 5% to about 50% of an overall thickness of a current collector by removing material from the pasting surface.

Ablation may increase the exposure of elemental material of a current collector at a surface of the current collector. Ablation may provide for about 10% or greater, about 12% or greater, about 14% or greater, or even about 15% or greater of a surface of a current collector be exposed elemental material. Ablation may provide for about 50% or less, about 40% or less, about 30% or less, or even about 20% or less of a surface of a current collector be exposed elemental material. For example, ablation of a lead-based foil may result in about 12% to about 20% of elemental lead exposed at a pasting surface of the foil. The exposed elemental material at a surface of a current collector, including an amount before and after ablation, may be measured by electron spectroscopy for chemical analysis (ESCA). Ablating may also be suitable for not just increasing the amount of exposed elemental material, but also increasing an overall surface area of a current collector.

Ablation may increase an overall surface area of a current collector at a surface of the current collector. An increase in surface area may promote adhesion between a current collector and an active material, promote better flow of electrons between a current collector and active material, improve efficiency of a battery assembly, or a combination thereof. Ablation may increase a surface area of a current collector by changing a profile of one or more surfaces of the current collector. The one or more surfaces may be the pasting surface, the substrate surface, or both. The profile of one or more surfaces of a current collector prior to ablation may be substantially planar, non-planar, or both. The profile of one or more surfaces of a current collector after ablation may be substantially non-planar, planar, or both. The profile of one or more surfaces of a current collector may change after ablation from substantially planar to non-planar. A non-planar profile may refer to similar nonplanar structures as described hereinafter with respect to the battery plates. The non-planar profile may include projections, peaks, valleys, concave portions, convex portions, and the like. Ablation may be particularly beneficial in not just removing oxidation of elemental material but changing the profile of the elemental material to increase a surface area. For example, a substantially planar current collector may be ablated to remove oxidation and also create a non-planar surface, thus increasing the surface area. Ablating may occur at a single power level of an energy source or a plurality of power levels. A single power level or a plurality of power levels may be suitable for removing oxidation, contamination, changing a surface profile of a current collector, or a combination thereof. For example, a first lower power level of the energy source may be used to remove oxidation, contaminants, or both from a pasting surface of a current collector and then a second, higher power level of the energy source may be used to change the pasting surface from a substantially planar surface to a non-planar surface and thus increase a surface area of the pasting surface. As another example, the same power level of the energy source may be used to remove oxidation and contaminants from a pasting surface of a current collector while simultaneously changing the pasting surface from substantially planar to non-planar. The surface area of a current collector may be measured by confocal microscopy, optical microscope, the like, or any combination thereof. For example, a Keyence confocal laser microscope may be suitable for measuring a surface area of one or more surfaces of a current collector. In addition to removing material from a current collector to promote adhesion or increase operating efficiency, ablating may include forming one or more patterns on a surface of a current collector.

Ablating may include forming one or more patterns on a surface of a current collector. The one or more patterns may function to identify a particular current collector, distinguish a current collector from another, provide assembly instructions, or a combination thereof. The one or more patterns may be located on the pasting surface, substrate surface, or both. The one or more patterns may include one or more items of text, images, the like, or a combination thereof. The one or more patterns may include one or more pieces of identification information, assembly instructions, the like, or a combination thereof. Identification information may include one or more part numbers, corporate identifiers (e.g., company name, logo), manufacturing sequence identifiers (e.g., build date, build sequence, etc.), the like, or any combination thereof. One or more assembly instructions may include one or more items of text and/or images which are able to aid in assembly of a current collector as part of a battery plate. One or more assembly instructions may indicate which surface is substrate surface, pasting surface, or both. One or more assembly instructions may indicate which surface should be placed on a substrate, which surface receives an active material thereon, or both. The one or more patterns may be created during the ablating step by one or more lasers.

Ablating may be performed by one or more energy sources. The one or more energy sources may be any suitable energy source for removing material from the current collector. The one or more energy sources may come directly into contact with or be free of direct contact with a surface of the current collector. The one or more energy sources which are free of direct contact with the current collector may be referred to as one or more non-contact energy sources. One or more non-contact energy sources may emit one or more types of energy. The emitted energy may be any suitable energy which is able to remove oxidation, contaminants, material of a current collector, or any combination thereof. The emitted energy may include laser, infrared energy, radiofrequency, plasma, microwave, the like, or any combination thereof. The emitted energy may be applied by a plurality of energy sources or a single energy source. The emitted energy may be applied in a continuous and/or discontinuous manner. For example, the energy source may be a continuous wave laser. A discontinuous manner may be a pulsed emission of energy. For example, the energy source may be a pulsed laser. One or more lasers may include one or more fiber lasers, diode lasers, yttrium aluminum garnet (YAG) lasers, lamp-pumped lasers, chemical lasers, electrical excitation lasers, the like, or any combination thereof. The one or more lasers may have a certain associated power rating. The power rating and power level may be selected based on the material and thickness of a current collector. A power rating and power level may allow a laser to be sufficiently powerful for only a single pass of a laser over a surface of a current collector to remove a desired amount of material. A higher power rating may allow for a laser to remove material from a current collector at a faster speed. A power rating may be about 10 watts or greater, about 50 watts or greater, about 75 watts or greater, or even about 100 watts or greater. A power rating may be about 5,000 watts or less, about 1,000 watts or less, or even about 500 watts or less. The power level selected during ablation may be a portion of or all of the power capability of the laser. The power level during all or a portion of the ablating may be about 0.01% or greater, about 0.02% or greater, or even about 0.05% or greater of the power capability of the laser. The power level during all or a portion of the ablating may be about 100% or less, about 50% or less, about 10% or less, or even about 1% or less of the power capability of the laser. A laser may have a spot size. The spot size may refer to the radius of one or more beams of a laser. The spot size of a laser may be about 10 microns or greater, about 25 microns or greater, about 50 microns or greater, or even about 75 microns or greater. The spot size of a laser may be about 1,000 microns or less, about 500 microns or less, or even about 100 microns or less. An exemplary laser may be an IPG brand 100-watt fiber laser with a Galvo scan head.

The method includes pasting a current collector with an active material. Pasting of the active material onto the current collector allows the active material to bond with and become in electrical contact with the current collector. Pasting of the active material to the current collector may be performed before or after adhering of a current collector to a substrate. Any suitable method may be used to apply the active material to the current collector. Methods for applying the active material may include application of the active material directly onto the current collector, directly onto a transfer sheet, or both. The active material may be applied via extrusion, spray coating, brushing, roll coating, printing, the like, or any combination thereof. The active material may be applied with the use of belt pasting equipment. For example, the substrate with the current collector thereon may pass under a paste box and have the active material applied thereon. The active material may be applied with the use of a transfer sheet. For example, a transfer sheet may be passed under a paste box and have the active material disposed thereon. The transfer sheet and active material may then be transferred so that the active material contacts and bonds with the current collector. Suitable methods of pasting an active material are disclosed in PCT Application Nos. PCT/US2010/021480 and PCT/US2018/033435, incorporated herein by reference in its entirety for all purposes.

The method includes curing and drying an active material on a current collector. The method may include exposing a battery plate, plurality of battery plates, a stack of a plurality of battery plates, and/or a battery assembly to conditions at which the one or more active materials cure. The active material may be cured by exposing the active material to temperatures of about 15° C. or greater, about 20° C. or greater, about 30° C. or greater, or even about 40° C. or greater. The active material may be cured by exposing the active material to temperatures of about 95° C. or less, about 90° C. or less, about 80° C. or less, or even about 70° C. For example, an active material in paste form may be cured by being exposed to a first temperature of about 40° C. to about 70° C. for about 12 to about 48 hours. The active material may be cured by exposing the active material to a second temperature and drying. The active material may be dried by exposing the active material to temperatures of about 25° C. or greater, about 30° C. or greater, about 40° C. or greater, or even about 50° C. or greater. The active material may be dried by exposing the active material to temperatures of about 105° C. or less, about 100° C. or less, about 90° C. or less, or even about 80° C. For example, an active material in paste form may be dried being exposed to a second or higher temperature of about 50° C. to about 80° C. for about 24 to about 72 hours.

Battery Plate(s)

The disclosure relates to battery plates useful in use as bipolar plates, monopolar plates, dual polar plates, the like or any combination thereof. A battery plate may function as one or more electrodes, include one or more electroactive materials, be part of an electrochemical cell, form part of one or more sealing structures, or any combination thereof. A plurality of battery plates may function to conduct an electric current (i.e., flow of ions and electrons) within the battery assembly. A plurality of battery plates may form one or more electrochemical cells. For example, a pair of battery plates, which may have a separator and/or electrolyte therebetween, may form an electrochemical cell. The number of battery plates present can be chosen to provide the desired voltage of the battery. The battery assembly design provides flexibility in the voltage that can be produced. The plurality of battery plates can have any desired cross-sectional shape and the cross-sectional shape can be designed to fit the packaging space available in the use environment. Cross-sectional shape may refer to the shape of the plates from the perspective of the faces of the sheets. Flexible cross-sectional shapes and sizes allow preparation of the assemblies disclosed to accommodate the voltage and size needs of the system in which the batteries are utilized. Opposing end plates may sandwich a plurality of battery plates therebetween. The one or more battery plates may include one or more nonplanar structures.

A nonplanar structure may mean that the shape of a surface of the battery plates may be any shape in which the plates can function. A nonplanar structure may be any feature which projects from and/or caves into a planar portion of a battery plate. A nonplanar structure may mean that a battery plate may be a nonplanar battery plate. A nonplanar structure may include one or more indented surfaces and/or protruding surfaces with respect to any plane passing through the plates. One or more nonplanar structures may be shapes which are regular or irregular. The shapes may include one or more concave or convex surfaces. Included in nonplanar structures are rectangles, cylinders, hemisphere, pyramid, saw tooth, and the like. One or more nonplanar structures may include one or more inserts, bosses, frames, projections, openings, ribs, corrugated structures, or any combination thereof. The one or more nonplanar structures may function to form one or more seals, channels, or both. The one or more nonplanar structures may be part of a substrate. The one or more nonplanar structures may function to increase an overall surface area of a substrate, battery plate, or both. For example, a substrate having a corrugated surface may have a larger surface area than a substrate with a relatively planar surface. A larger surface area may allow for increased voltage, current, or both. The one or more nonplanar structures may be within any portion of a battery plate. Within a stack of battery plates, the planar and/or nonplanar structure of the battery plates may be the same so as to provide for efficient functioning of the electrochemical cells that they assist in forming. The plurality of battery plates may include one or more monopolar plates, one or more bipolar plates, or any combination thereof.

One or more battery plates may include one or more bipolar plates. The one or more bipolar plates may include a single or a plurality of bipolar plates. Plurality as used herein means that there are more than one of the plates. A bipolar plate comprises a substrate. The substrate may be in the form of a sheet having two opposing faces. Located on the opposing faces are a cathode and an anode. The cathode and the anode may be in the form of a paste applied onto the substrate. The cathode, the anode, or both may include a transfer sheet. The bipolar plates may be arranged in a battery assembly in one or more stacks so that the cathode of one bipolar plate faces the anode of another bipolar plate or a monopolar plate, and the anode of each bipolar plate faces the cathode of a bipolar or monopolar plate.

One or more battery plates may be one or more monopolar plates. The one or more monopolar plates may include a single or a plurality of monopolar plates. The one or more monopolar plates may include a monopolar plate located at each opposing end of a plurality of battery plates. Opposing monopolar plates may include one or more bipolar plates located therebetween. One or more monopolar plates may be located adjacent to, may be part of, or may be, one or more end plates. For example, each of the monopolar plates may be located between an adjacent end plate and an adjacent bipolar plate. One or more monopolar plates may be attached to one or more end plates. One or more monopolar plates may be affixed to an end plate as taught in any of U.S. Pat. Nos. 8,357,469; 9,553,329; and US Patent Application Publication No. 2017/0077545; incorporated herein by reference in their entirety for all purposes. One or more monopolar plates may be one or more end plates as taught in U.S. Pat. No. 10,141,598; incorporated herein by reference in its entirety for all purposes. One or more monopolar plates, such as when in the form of end plates, may include one or more reinforcement structures as disclosed in US Patent Application Publication No. 2017/0077545. One or more monopolar plates may be prepared from the same substrates, anodes, and cathodes used in one or more of the bipolar plates. One monopolar plate of a battery assembly may have a substrate with a cathode disposed thereon. One monopolar plate of a battery assembly may have a substrate with an anode disposed thereon. The cathode, anode, or both may be in the form of a paste applied onto the substrate. The cathode, the anode, or both may include a transfer sheet. A surface or side of a monopolar plate opposing the anode or cathode and/or facing an end plate may be a bare surface of a substrate.

One or more battery plates may include one or more dual polar plates. A dual polar battery plates may function to facilitate electrically connecting one or more stacks of battery plates with one or more other stacks of battery plates, simplify manufacturing and assembly of the two or more stacks, or both. Using dual polar plate stacks to electrically connect two or more stacks of battery plates may allow the individual stacks of battery plates to be formed as a standard size (e.g., number of plates and/or electrochemical cells) and then assembled to form the bipolar battery assembly; easily vary the number of individual stacks of battery plates to increase or decrease the power generated by the bipolar battery assembly; or both. The dual polar plates may include one or more substrates. One or more substrates may include a single substrate or a plurality of substrates. One or more substrates may include one or more conductive substrates, one or more non-conductive substrates, or a combination of both. A plurality of conductive substrates may include a first conductive substrate and a second conductive substrate. For example, a dual polar plate may comprise a first conductive substrate and a second conductive substrate with a nonconductive substrate located therebetween. As another example, the dual polar plate may comprise a nonconductive substrate. As another example, the dual polar plate may comprise a single conductive substrate. The one or more substrates of the dual polar plate include opposing surfaces. The opposing surfaces may have an anode, cathode, current conductor, current collector, or any combination thereof deposited and/or in contact with a portion of the surface. A conductive substrate of the dual polar plate may have an anode or cathode deposited on a surface or on both opposing surfaces. Having the same anode or cathode on the opposing surfaces may simplify manufacturing by requiring only one electrical connection (e.g., via a positive or negative current conductor) to another current conductor of the one or more stacks (e.g., a positive or negative current conductor or terminal of a monopolar plate). A substrate of the dual polar plate may have a current collector disposed on one or both opposing surfaces. The current collector may be disposed between the cathode or the anode and a surface of the substrate. Exemplary dual polar plates and integration into a battery assembly are disclosed in U.S. Pat. Nos. 9,685,677; 9,825,336; and US Patent Application Publication No.: 2018/0053926; incorporated herein by reference in their entirety for all purposes.

One or more battery plates include one or more substrates. One or more substrates may function to provide structural support for the cathode and/or the anode; as a cell partition so as to prevent the flow of electrolyte between adjacent electrochemical cells; cooperating with other battery components to form an electrolyte-tight seal about the battery plate edges, which may be on the outside surface of the battery; and, in some embodiments, to transmit electrons from one surface to the other. The substrate can be formed from a variety of materials depending on the function or battery chemistry. The substrate may be formed from materials that are sufficiently structurally robust to provide the backbone of a desired battery plate, withstanding temperatures that exceed the melting points of any conductive materials used in the battery construction, and having high chemical stability during contact with an electrolyte (e.g., sulfuric acid solution) so that the substrate does not degrade upon contact with an electrolyte. The substrate may be formed from suitable materials and/or is configured in a manner that permits the transmission of electricity from one surface of the substrate to an opposite substrate surface. The substrate may be formed from an electrically conductive material, e.g., a metallic material, or can be formed from an electrically non-conductive material. Exemplary non-conductive material may include polymers, such as thermoset polymers, elastomeric polymers, or thermoplastic polymers, or any combination thereof. The substrate may comprise a generally non-electrically conductive substrate (e.g., a dielectric substrate). The non-conductive substrate may have electrically conductive features constructed therein or thereon. Examples of polymeric materials that may be employed include polyamide, polyester, polystyrene, polyethylene (including polyethylene terephthalate, high density polyethylene and low-density polyethylene), polycarbonates (PC), polypropylene, polyvinyl chloride, bio-based plastics/biopolymers (e.g., polylactic acid), silicone, acrylonitrile butadiene styrene (ABS), or any combination thereof, such as PC/ABS (blends of polycarbonates and acrylonitrile butadiene styrenes). Composite substrates may be utilized. The composite may contain reinforcing materials, such as fibers or fillers commonly known in the art; two different polymeric materials, such as a thermoset core and a thermoplastic shell or thermoplastic edge about the periphery of the thermoset polymer; or conductive material disposed in a non-conductive polymer. The substrate may comprise or have at the edge of the plates a thermoplastic material that is bondable, preferably melt bondable. The one or more substrates may have one or more nonplanar structures. The one or more nonplanar structures may be integral with the substrate or affixed to the substrate. The one or more nonplanar structured may be molded as part of the substrate. The one or more nonplanar structures may include one or more raised edges, frames, inserts, protrusions, projections, openings, the like, or any combination thereof.

One or more substrates may have a raised edge about the periphery so as to facilitate stacking of the battery plates and formation of electrochemical cells. The raised edge as used in this context means a raised edge on at least one of the two opposing surfaces of the plates. The raised edge may comprise a thermoplastic edge portion formed about another substrate material. The raised edge may function as separator plates as described herein. The substrate or periphery of the substrate may be a non-conductive material and may be a thermoplastic material. One or more substrates may include a frame. The frame may or may not include the raised edge. The frame about or integrated onto the substrate may be comprised of non-conductive material, such as a thermoplastic material. The use of non-conductive material enhances sealing the outside of the battery stack. The frame may include one or more assembly aids formed therein. The assembly aids may function to help align and retain one or more substrates, separators, or both in place while stacking to form the battery assembly. The assembly aids may include one or more projections, indentations, or both. For example, one or more male projections from one surface of a frame may align and sit within one or more female wells of a frame of an adjacent substrate and/or separator. The one or more female wells of a frame may be located on an opposite surface of the frame as the one or more male projections.

One or more of the battery plates may include one or more current collectors. The one or more current collectors may function to dispose electrons flowing in the electrochemical cell, ensure electrical connection of one or more active materials to a substrate, collect current, or any combination thereof. The one or more current collectors may have any suitable form or shape to cooperate with one or more active materials of a substrate, transmit or receive electrons from one or more terminals, or both. The one or more current collectors may be in the form of a sheet, foil, grid, screen, mesh, the like, or any combination thereof. The one or more current collectors may be comprised of any one or more materials suitable for conducting current. The one or more materials may include one or more metals. The one or more metals may include silver, tin, copper, lead, alloys thereof, the like, or any combination thereof. The one or more materials may be chosen based on the one or more materials selected for the active material (e.g., cathode, anode, or both). For example, in a lead acid battery, the one or more current collectors may be comprised of lead, lead alloy, or both. The one or more current collectors may be located between a substrate and an active material, embedded within a substrate, embedded within an active material, in contact with a substrate, in contact with an active material, or any combination thereof. For example, a current collector in the form of a sheet may have one surface in contact with a substrate and an opposing surface in contact with an active material. As another example, a current collector in the form of a grid may have one surface in contact with a substrate and an opposing surface in contact with and partially embedded into an active material. A surface of a current collector which faces and/or is in contact with a substrate may be referred to as a substrate surface. A surface of a current collector which faces, is in contact with, and/or is embedded into an active material may be referred to as a pasting surface. A current collector may be located between only a portion of or an entire surface of an active material facing toward a substrate. An active material located between the entire surface of an active material facing toward the substrate may provide for more efficient current collection and dispersion. The current collector has a thickness. The thickness may be measured as the distance between a substrate surface and a pasting surface. The thickness may be sufficient to collect electrons and transmit to current conductors, disperse electrons flowing through an electrochemical cell, or both. The thickness of a current collector may be about 0.025 mm or greater, about 0.050 mm or greater, or even about 0.075 mm or greater. The thickness of a current collector may be about 0.75 mm or less, about 0.2 mm or less, or even about 0.1 mm or less. One or more current collectors may be affixed to a surface of a substrate. Any suitable method of affixing a current collector to a substrate may be used which suitably holds the current collector to the substrate before and during repeat operation of the battery assembly. Suitable methods of affixing a current collector to a substrate may include welding, adhesive bonding, the like, or both. For example, a current collector may be bonded to the substrate via one or more adhesives. The one or more adhesives may include one or more epoxies, rubber cements, phenolic resins, nitrile rubber compounds, cyanoacrylate glues, the like, or a combination thereof. An exemplary current collector may be a lead or lead alloy foil having a thickness of 150 microns.

One or more of the battery plates may include a cathode. The cathode can be in any material that is capable of functioning as a cathode in a battery and can be in any form commonly used in batteries. A bipolar plate may include a cathode on a surface opposing a surface having an anode deposited thereon and opposing an anode of either another bipolar plate or monopolar plate. A monopolar plate may have a cathode deposited on a surface opposing a surface bare of either a cathode or anode, opposing a surface adjacent to an end plate, or both. The cathode is also referred to as positive active material (PAM). The positive active material may comprise a composite oxide, a sulfate compound or a phosphate compound of lithium, lead, carbon or a transition metal generally used in a lithium ion, nickel metal hydride or lead acid secondary battery. Examples of the composite oxides include Li/Co based composite oxide such as LiCoO₂, Li/Ni based composite oxide such as LiNiO₂, Li/Mn based composite oxide such as spinel LiMn₂O₄, and Li/Fe based composite materials such as LiFeO₂. Exemplary phosphate and sulfur compounds of transition metal and lithium include LiFePO₄, V₂O₅, MnO₂, TiS₂, MoS₂, MoO₃, PbO₂, AgO, NiOOH, and the like. The cathode material can be in any form which allows the cathode material to function as a cathode in an electrochemical cell. Exemplary forms include formed parts, in paste form, pre-fabricated sheet or film. For lead acid in batteries, the preferred cathode material is lead dioxide (PbO₂).

One or more of the battery plates may include an anode. The anode can be any material that is capable of functioning as an anode in a battery and can be in any form commonly used in batteries. A bipolar plate may include an anode on a surface opposing a surface having a cathode deposited thereon and opposing cathode of either another bipolar plate or monopolar plate. A monopolar plate may have an anode deposited on a surface opposing a surface bare of either a cathode or anode, opposing a surface adjacent to an end plate, or both. The anodes are also referred to as negative active material (NAM). The anode material may include any material used in secondary batteries, including lead acid, nickel metal hydrides and lithium ion batteries. Exemplary materials useful in constructing anodes include lead, composite oxides of carbon or lithium and transition metals, (such as a composite oxide of titanium oxide or titanium and lithium) and the like. The anode material for a lead acid battery may be sponge lead. The cathode material can be in any form which allows the cathode material to function as a cathode in an electrochemical cell. Exemplary forms include formed parts, in paste form, pre-fabricated sheet or films. Paste compositions can contain a number of beneficial additives including floc or glass fibers for reinforcement, various ligano-organic compounds for paste stability and conductive additives such as carbon, particularly for negative active materials. For lead acid batteries the preferred form of the anode material is sponge lead. The anode and cathode are chosen to work together to function as an electrochemical cell once a circuit is formed which includes the cells.

The anodes and/or cathodes can be of any desired shape or thickness. The anode and/or cathode may have a matching, nonmatching, reciprocal, and/or nonreciprocal shape to a substrate, transfer sheet, or both on which the anode and/or cathode is disposed. An anode and/or cathode may have similarly formed nonplanar structures as a substrate, transfer sheet, or both. The anodes and/or cathodes may have a different shape than the substrates. The anode and/or cathode may have the one or more indentations, protrusions, projections, openings, ribs, corrugated structures, or a combination thereof formed therein which match and align with one or more indentations, projections, openings, ribs, corrugated structures, or a combination thereof of a substrate, transfer sheet, or both upon which the anode and/or cathode is disposed. One surface of an anode and/or cathode may be reciprocal with a substrate, transfer sheet, or both while an opposing surface is nonreciprocal. One surface of an anode and/or cathode may be reciprocal with a substrate, transfer sheet, or both while an opposing surface of the anode and/or cathode is reciprocal with another transfer sheet, substrate, or both. For example, a surface of an anode and/or cathode disposed on a substrate may be reciprocal with the surface substrate while the surface of the same and/or cathode disposed on a transfer sheet may be reciprocal with the surface of the transfer sheet.

The anodes and/or cathodes may have the same thickness across each or the thickness may vary. The anodes and/or cathodes may have a thickness of about 0.3 mm or greater, about 0.5 mm or greater, or even about 1 mm or greater. The anodes and/or cathodes may have a thickness of about 3 mm or less, about 2 mm or less, or even about 1.5 mm or less. The thickness of the layers of negative active material or positive active material disposed between one surface of the substrate and surface of the transfer sheet may be uniform or may vary as desired for the particular battery assembly. The thickness across the layer of negative active material, positive active material, or both may vary by about 0% or greater, about 25% or greater, or even by about 50% or greater. The thickness across the layer of negative active material, positive active material, or both may vary by about 90% or less, about 80% or less, or even about 75% or less.

One or more battery plates may include of be free of one or more transfer sheets. A transfer sheet may function to define one surface of the negative active material (e.g., anode) or positive active material (e.g., cathode), such as when formed in the mold; to facilitate transfer of the negative active material or positive active material from a mold to a surface of the substrate; or both. A transfer sheet may be disposed on a surface of the negative active material or positive active material. A transfer sheet may be disposed on a surface of the negative active material or positive active material opposite a surface in contact with a substrate. A transfer sheet may substantially cover the surface of the negative active material or positive active material. The surface of the negative active material or the positive active material opposite the transfer sheet may be in contact with a substrate. A transfer sheet may have any suitable shape for cooperating with a mold, substrate, positive active material, negative active material, or a combination thereof. A transfer sheet may be planar, nonplanar, or both. A transfer sheet may include one or more nonplanar structures. The nonplanar structures may be protrusions, projections, indentations, openings, ribs, corrugated structures, or a combination thereof. One or more nonplanar structures may be formed reciprocal or nonreciprocal to those of a substrate. The transfer sheet may include one or more openings. The one or more openings may align with on one or more openings of a substrate. The openings may share one or more of the same features as those described relative to the substrate. One or more nonplanar structures may be nonreciprocal to those of a substrate. For example, a transfer sheet may have a corrugated structure while a substrate is generally planar. The corrugated structure may allow a surface of the positive active material or negative active material applied on the transfer sheet to have a reciprocal corrugated structure while an opposing surface is substantially planar and conforms with the substrate. When the negative active material or positive active material in the shape formed in the mold is transferred to the substrate, the negative active material or positive active material are bonded on one surface to the substrate and on the opposing surface to the transfer sheet. The layer of negative active material or positive active material may be a relatively thin layer between one surface of the substrate and a surface of the transfer sheet. Thus, the edges of such layers are relatively thin and can be protected by the structures formed. For example, the edges of the negative active material, positive active material, transfer sheet, or any combination thereof may be protected by a frame of a battery plate, substrate, or both. Suitable transfer sheets may be those disclosed in PCT Publication No. WO 2018/213730, incorporated herein by reference in its entirety.

The transfer sheet may be prepared from one or more materials. The one or more materials may function to resist corrosion, allow transfer of ions from an anode to a cathode and/or vice versa, or any combination thereof. A transfer sheet may be prepared from any material which may not degrade in the presence of an electrolyte. An electrolyte, such as sulfuric acid, may be quite corrosive. A transfer sheet may be porous. A porous material may be advantageous to allow electrolyte containing ions to pass through the transfer sheet. By allowing the electrolyte to pass through, the transfer sheet cooperates as part of the electrochemical cells to allow the anode and cathodes to function to collectively generate electrons. The pores may have a suitable size such that the transfer paste does not pass through the transfer sheet. The transfer sheet may comprise any material that can withstand exposure to the electrolyte; can release from the mold base and bond to the negative active material and positive active material; prevent passage of the positive active material and negative active material therethrough; and can form the desired pores. The pores of the transfer sheet can be formed by any means which provides the desired pore size. A desired pore size may be in the micron range. A pore size of pores of a transfer sheet may be about 35 microns or greater, about 150 microns or greater, about 250 microns or greater, or even about 500 microns or greater. A pore size of pores of a transfer sheet may be about 2,000 microns or less, about 1,500 microns or less, about 1,000 microns or less, or even about 800 microns or less. The transfer sheet can be formed from woven and non-woven structures. The transfer sheet may be formed from sheets of suitable material that are processed to introduce pores. Processes to introduce pores may include chemical pore formers, punching, drilling, and the like. Examples of such structures include absorbent glass mats, scrim, pasting papers, cellulose and the like. The transfer sheets may be prepared from glass or polymeric materials. Useful polymeric materials may be polyesters, polyolefins, natural or synthetic rubbers, natural cellulose, synthetic cellulose and the like. Exemplary materials that the transfer sheets may be prepared from include polyetheylene separators, porous rubber separators, or both. Suitable polyethylene separators may include RhinoHide from Entek and various Daramic materials. Suitable porous rubber separators may be those from Amerace, AGM, Hollingworth & Vose, and the like. The transfer sheets may have any thickness that functions to hold the active materials in place, allows for transfer from a mold to a substrate, allows transfer of electrolyte and ions therethrough, or any combination thereof. The thickness of the transfer sheets may be about 10 μm or greater, about 250 μm or greater, or even about 500 μm or greater. The thickness of the transfer sheets may be about 4 mm or less, about 2 mm or less, or even about 1 mm or less.

The bipolar plates or monopolar plates having negative active materials or positive active materials on the surface may have a transfer sheet bonded to the active materials. Active material may refer to an electroactive material, cathode, anode, transfer sheet bonded to a cathode or anode, or any combination thereof. Before assembly of battery plates and battery assemblies, the transfer sheets may function to protect the active material, support transfer of the active material from a mold to a substrate, allow for one or more nonplanar structures to be formed within the active material, or any combination thereof. Once the battery plates are assembled as part of a battery assembly, one or more transfer sheets may reside within one or more electrochemical cells. One or more transfer sheets may function in conjunction with or in lieu of a separator to perform the function of the separator.

Battery Assembly

A battery assembly may include one or more electrochemical cells. An electrochemical cell may be formed by a pair of opposing battery plates with an opposing anode and cathode pair therebetween. One or more electrochemical cells may be sealed. The space of an electrochemical cell (i.e., between an opposing anode and cathode pair) may contain one or more separators, transfer sheets, electrolyte, or a combination thereof. For example, the space of an electrochemical cell may include two transfer sheets, a separator therebetween, and electrolyte. For example, the space of an electrochemical cell may include two transfer sheets and electrolyte while being free of a distinct separator. The electrochemical cells may be sealed through one or more seals formed about one or more channels; one or more frames and/or edges of battery plate, separators, or both; a membrane and/or casing about the stack of battery plates (and separators); or any combination thereof which may form closed electrochemical cells. The battery assembly may not require a separate seal (e.g., membrane and/or casing). The closed electrochemical cells may be sealed from the environment to prevent leakage and short circuiting of the cells.

A battery assembly may include an electrolyte. The electrolyte may allow electrons and ions to flow between the anode and cathode. The electrolyte may be located within the electrochemical cells. As the one or more electrochemical cells may be sealed, the electrolyte may be a liquid electrolyte. The electrolyte can be any liquid electrolyte that facilitates an electrochemical reaction with the anode and cathode utilized. The electrolytes can be water based or organic based. The organic based electrolytes useful herein comprises an electrolyte salt dissolved in an organic solvent. In lithium ion secondary batteries, it is required that lithium be contained in the electrolyte salt. For the lithium-containing electrolyte salt, for instance, use may be made of LiPF₆, LiClO₄, LiBF₄, LiAsF₆, LiSO₃CF₃ and LiN(CF₃SO₂)₂. These electrolyte salts may be used alone or in combination of two or more. The organic solvent should be compatible with the separator, transfer sheet, cathode and anode, and the electrolyte salt. It is preferable to use an organic solvent that does not decompose even when high voltage is applied thereto. For instance, it is preferable to use carbonates such as ethylene carbonate (EC), propylene carbonate (PC), butylene carbonate, dimethyl carbonate (DMC), diethyl carbonate and ethyl methyl carbonate; cyclic ethers such as tetrahydrofuran (THF) and 2-methyltetrahydrofuran; cyclic esters such as 1,3-dioxolane and 4-methyldioxolane; lactones such as γ-butyrolactone; sulfolane; 3-methylsulfolane; dimethoxyethane, diethoxyethane, ethoxymethoxymethane and ethyldiglyme. These solvents may be used alone or in combination of two or more. The concentration of the electrolyte in the liquid electrolyte should preferably be 0.3 to 5 mol/l. Usually, the electrolyte shows the highest conductivity in the vicinity of 1 mol/l. The liquid electrolyte should preferably account for 30 to 70 percent by weight, and especially 40 to 60 percent by weight of the electrolyte. Aqueous electrolytes comprise acids or salts in water which enhance the functioning of the cell. Preferred salts and acids include sulfuric acid, sodium sulfate or potassium sulfate salts. The salt or acid is present in a sufficient amount to facilitate the operation of the cell. The concentration may be about 0.5 weight percent of greater based on the weight of the electrolyte, about 1.0 or greater or about 1.5 weight percent or greater. A preferred electrolyte in a lead acid battery is sulfuric acid in water. The electrolyte may be able to pass through one or more separators, transfer sheets, or both of an electrochemical cell.

The battery assembly may include or be free of one or more separators. The one or more separators may function to partition an electrochemical cell (i.e., separate a cathode of an electrochemical cell from an anode of an electrochemical cell); prevent short circuiting of the cells due to dendrite formation; allow liquid electrolyte, ions, electrons or any combination of these elements to pass through; or any combination thereof. Any known battery separator which performs one or more of the recited functions may be utilized in the battery assemblies of the present teachings. One or more separators may be located between anode and a cathode of an electrochemical cell. One or more separators may be located between a pair of adjacent battery plates, which may include between bipolar plates or between a bipolar plate and a monopolar plate. The separator may be prepared from a non-conductive material, such as porous polymer films, glass mats, porous rubbers, ionically conductive gels or natural materials, such as wood, and the like. The separator may contain pores or tortuous paths through the separator which allows electrolyte, ions, electrons or a combination thereof to pass through the separator. The pores may be sized as described herein relative to the pore size of a transfer sheet. Among exemplary materials useful as separators are absorbent glass mats, and porous ultra-high molecular weight polyolefin membranes and the like. The separators may be attached about their periphery and/or interior to one or more end plates, battery plates, other separators, or any combination thereof. The separators may receive one or more posts therethrough. For example, one or more posts extending through a stack of one or more end plates, one or more battery plates, and/or one or more separators may retain a stack of a plurality of battery plates and one or more separators together. The separators may have a cross-section or surface area that is greater than the area of the adjacent cathode and anode. A larger area may allow for isolation of the anode from the cathode of the same electrochemical cell. The separator may completely separate the cathode portion of the cell from the anode portion of the cell. The edges of the separator may contact peripheral edges of adjacent battery plates. The edges of the separator, battery plate, or both may not have an anode or cathode disposed thereupon, so as to completely separate the anode portion of the cell from the cathode portion of the cell. The application of the active material to a transfer sheet, and then the transfer sheet to the substrate may be particularly advantageous in ensuring the edges of the separator and battery plates are free of the active material. The use of one or more transfer sheets within an electrochemical cell may allow for the electrochemical cell to be free of a separator if desired.

One or more separators may include frames. The frames may function to match with the edges or frames of adjacent battery plates and form a seal between the electrochemical cells and the outside of the battery. The frame may be attached to or integral with a separator. The frame can be attached to the separator about the periphery of the sheet forming the separator using any means that bonds the separator to the frame and which can withstand exposure to the electrolyte solution. For example, the frame may be attached by adhesive bonding, melt bonding or molding the frame about the periphery of the separator. The frame can be molded in place by any known molding technic, for example thermoforming, injection molding, roto molding, blow molding, compression molding and the like. The frame may be formed about the separator sheet by injection molding. The frame may contain a raised edge adapted to match raised edges disposed about the periphery of the substrates for the battery plates. Raised edges in one or both of the battery plate substrates and the frames of the separators can be matched to form a common edge for the battery stack and to enhance the seal between the electrochemical cells and the outside of the battery. To seal about edges of the plurality of battery plates and one or more separators to prevent leakage of an electrolyte and evolved gasses from the electrochemical cells, isolate the electrochemical cells to prevent short-circuiting, the battery assembly may be sealed using an endo or exoskeleton sealing system as disclosed in commonly owned US Patent Publication Nos. 2010/0183920, 2014/0349147, 2015/0140376, and 2016/0197373 incorporated in their entirety by reference.

The battery assembly may include one or more inserts. One or more inserts may include a plurality of inserts. The one or more inserts may function to interlock with one or more other inserts, define a portion of one or more channels passing through the stack, form leak proof seal along one or more channels, cooperate with one or more valves, or any combination thereof. One or more inserts may be part of one or more end plates, battery plates, separators, or any combination thereof. One or more inserts may be free of active material, transfer sheet, or both. The one or more inserts may have any size and/or shape to interlock with one or more inserts of a battery plate, end plate, separator, or combination thereof form a portion of a channel, form a leak proof seal along one or more channels, cooperate with one or more valves, or any combination thereof. The one or more inserts may be formed or attached to an end plate, substrate of a battery plate, separator, or combination thereof. The one or more inserts may be located within the periphery of a battery plate, separator, end plate, or combination thereof. One or more inserts may project from a surface of a substrate, separator, end plate, or combination thereof thus forming one or more raised inserts. One or more inserts may project from a substrate of a battery plate, a central portion of a separator, or both. One or more inserts may project substantially orthogonally or oblique from a surface of the substrate, separator, end plate, or combination thereof. One or more inserts may be attached to or integral with a portion of the battery plate, separator, end plate, or combination thereof. An insert which is integral with and projects from a surface may be defined as a boss. The opposing surface from which the insert projects therefrom may have a reciprocal indentation to allow forming of the boss. The reciprocal indentation may receive another insert therein, thus allowing formation of a channel. The one or more inserts may have one or more openings therethrough. The one or more inserts may be concentric and formed about one or more openings. One or more inserts may extend a length of an opening. A sealing surface may be formed between the outer diameter of one or more openings and an interior of one or more inserts. For example, a surface of the substrate, end plate, and/or separator may be substantially perpendicular to a longitudinal axis of the battery assembly located between an insert and an opening may be a sealing surface. One or more inserts may be capable of interlocking with one or more inserts of an adjacent battery plate, separator, and/or end plate to form a leak proof seal about a channel. For example, one or more battery plates may be machined or formed to contain matching indents, on a surface opposite from an insert, for bosses, inserts, sleeves, or bushings of a separator, battery plate, and/or end plate. The one or more inserts may pass through one or more nonplanar structures of one or more active materials, transfer sheets, or both. For example, one or more inserts may pass through an opening (e.g., void) of an active material and transfer sheet to allow interlocking with an adjacent insert. One or more suitable inserts may be those disclosed in U.S. Pat. Nos. 8,357,469; 9,553,329; and US Patent Application Publication No. 2017/0077545; incorporated herein by reference in their entirety for all purposes. One or more inserts may contain one or more vent holes. One or more inserts of one or more separators may contain one or more vent holes. The one or more vent holes may allow communication of selected fluids from one or more electrochemical cells to one or more channels. Each of the electrochemical cells may be independently electrochemically formed.

The battery assembly may include one or more openings. The one or more openings may include a plurality of openings. The openings may function to form one or more channels; house one or more seals; affix one or more end plates, battery plates, separators, or combination thereof to one another; or any combination thereof. The one or more openings may be formed in one or more of the end plates, battery plates, separators, active material, transfer sheets, or any combination thereof. One or more openings of an end plate, battery plate, separator, active material, transfer sheet, or combination thereof may align (i.e., be substantially concentric) with one or more openings of one or more other end plates, battery plates, separators, active material, transfer sheet, or any combination thereof. The one or more openings may align in a transverse direction across the length of the battery assembly. The transverse direction may be substantially parallel to a longitudinal axis of the battery assembly. The transverse direction may be substantially perpendicular the opposing surfaces of the substrates upon which a cathode and/or anode may be deposited. The openings may be machined (e.g., milled), formed during fabrication of the substrate (e.g., by a molding or shaping operation), or otherwise fabricated. Openings in a paste may be formed during a past application process. The openings may have straight and/or smooth internal walls or surfaces. The size and frequency of the openings formed in the substrate may affect the resistivity of the battery. The one or more openings may have a diameter able to receive a post therethrough. One or more openings in an active material and/or transfer sheet may have a diameter able to receive a post, an insert, or both therethrough. The openings may have a diameter of about 0.2 mm or greater, about 1 mm or greater, about 2 mm or greater, or even about 5 mm or greater. The openings may have a diameter of about 30 mm or less, about 25 mm or less, or even about 20 mm or less. One or more openings of a transfer sheet and/or active material (e.g., paste) may have a diameter larger than a diameter of an opening and/or insert of a separator, substrate, battery plate, end plate, or combination thereof. One or more openings of a battery plate and/or substrate may have a larger diameter than one or more other openings of the same battery plate and/or substrate. An opening may be about at least about 1.5 times, at least about 2 times, or even at least about 2.5 times larger than another opening. An opening may be about 4 times or less, about 3.5 times or less, or even about 3 times or less larger than another opening. The openings may be formed having a density of at least about 0.02 openings per cm². The openings may be formed having a density of less than about 4 openings per cm². The openings may be formed having a density from about 2.0 openings per cm² to about 2.8 openings per cm².

One or more openings may be filled with an electrically conductive material, e.g., a metallic-containing material. The electrically conductive material may be a material that undergoes a phase transformation at a temperature that is below the thermal degradation temperature of the substrate so that at an operating temperature of the battery assembly that is below the phase transformation temperature, the dielectric substrate has an electrically conductive path via the material admixture between the first surface and the second surface of the substrate. Further, at a temperature that is above the phase transformation temperature, the electrically conductive material admixture undergoes a phase transformation that disables electrical conductivity via the electrically conductive path. For instance, the electrically conductive material may be or include a solder material, e.g., one comprising at least one or a mixture of any two or more of lead, tin, nickel, zinc, lithium, antimony, copper, bismuth, indium, or silver. The electrically conductive material may be substantially free of any lead (i.e., it contains at most trace amounts of lead) or it may include lead in a functionally operative amount. The material may include a mixture of lead and tin. For example, it may include a major portion tin and a minor portion of lead (e.g., about 55 to about 65 parts by weight tin and about 35 to about 45 parts by weight lead). The material may exhibit a melting temperature that is below about 240° C., below about 230° C., below about 220° C., below 210° C. or even below about 200° C. (e.g., in the range of about 180 to about 190° C.). The material may include a eutectic mixture. A feature of using solder as the electrically conductive material for filling the openings is that the solder has a defined melting temperature that can be tailored, depending on the type of solder used, to melt at a temperature that may be unsafe for continued battery operation. Once the solder melts, the substrate opening containing the melted solder is no longer electrically conductive and an open circuit results within the battery plate. An open circuit may operate to dramatically increase the resistance within the bipolar battery thereby stopping further electrical flow and shutting down unsafe reactions within the battery. Accordingly, the type of electrically conductive material selected fill the openings can vary depending on whether it is desired to include such an internal shut down mechanism within the battery, and if so at what temperature it is desired to effect such an internal shutdown. The substrate will be configured so that in the event of operating conditions that exceed a predetermined condition, the substrate will function to disable operation of the battery by disrupting electrical conductivity through the substrate. For example, the electrically conductive material filling holes in a dielectric substrate will undergo a phase transformation (e.g., it will melt) so that electrical conductivity across the substrate is disrupted. The extent of the disruption may be to partially or even entirely render the function of conducting electricity through the substrate disabled.

The battery assembly may include one or more channels. The one or more channels may function as one or more venting, filling, and/or cooling channels; house one or more posts; distribute one or more posts throughout an interior of the battery assembly; prevent liquid electrolyte from coming into contact with one or more posts or other components; or any combination thereof. The one or more channels may be formed by one or more openings of one or more end plates, battery plates, and/or separators, which are aligned. The one or more channels may extend through one or more openings of active material, transfer sheets, or both. The one or more channels may be referred to as one or more integrated channels. The one or more channels may pass through one or more electrochemical cells. The one or more channels may pass through a liquid electrolyte. The channels may be sealed to prevent electrolytes and gasses evolved during operation from entering the channels. Any method of sealing which achieves this objective may be utilized. One or more seals, such as inserts of the one or more end plates, battery plates, and separators, may interlock and surround one or more channels to prevent the liquid electrolyte from leaking into one or more channels. The one or more channels may pass through the battery assembly in a transverse direction to form one or more transverse channels. The size and shape of the channels can be any size or shape that allows them to house one or more posts. The shape of the channels may be round, elliptical, or polygonal, such as square, rectangular, hexagonal and the like. The size of the channels housing one or more posts is chosen to accommodate the posts used. The diameter of the channel may be equal to the diameter of the openings which align to form one or more channels. The one or more channels comprise a series of openings in the components arranged so a post can be placed in the channel formed, so a fluid can be transmitted through the channel for cooling, and/or for venting and filling. The number of channels is chosen to support the end plate and edges of the end plates, battery plates, and separators to prevent leakage of electrolyte and gasses evolved during operation, and to prevent the compressive forces arising during operation from damaging components and the seal for the individual electrochemical cells. A plurality of channels may be present so as to spread out the compressive forces generated during operation. The number and design of channels is sufficient to minimize edge-stress forces that exceed the fatigue strength of the seals. The locations of a plurality of channels are chosen so as to spread out the compressive forces generated during operation. The channels may be spread out evenly through the stack to better handle the stresses. The plurality of channels may have a cross-sectional size of about 2 mm or greater, about 4 mm or greater, or about 6 mm or greater. The upper limit on the cross-sectional size of the channels is practicality. If the size is too large, the efficiency of the assemblies is reduced. The channels may have a cross-sectional size of about 30 mm or less, about 25 mm or less, or even about 20 mm or less. A nonplanar surface of active material may allow for compensation or improved efficiency while the channels have a larger cross-sectional size. For example, a corrugated form of the active material may allow for the increased surface area and thus improved efficiency of the battery assembly.

The battery assembly may comprise a seal between one or more channels and one or more posts. One or more seals may be located in a channel, about an exterior of a channel, and/or about a post. The seal may comprise any material or form that prevents electrolyte and gasses evolved during operation from leaking from the electrochemical cells. The seal can be a membrane, sleeve, or series of matched inserts in the end plates, battery plates, and/or separators, or inserted in the channel. The membrane can be elastomeric. The channel can be formed by a series of sleeves, bushings, inserts and/or bosses, inserted or integrated into the plates and/or separators. The inserts and/or bosses may be compressible or capable of interlocking with one another to form a leak proof seal along the channel. The inserts and/or bosses may be formed in place in the battery plates and/or separators, such as by molding them in place. The inserts and/or bosses may be molded in place by injection molding. The seal can be prepared from any material that can withstand exposure to the electrolyte, operating conditions of the electrochemical cells and forces exerted by inserting the post or by the post in the channel. The preferred polymeric materials that are described as useful for the posts and the substrates. The seal may be formed by sleeves, inserts or bushings placed between the bipolar and monopolar plates. The sleeves or inserts can relatively rigid and the bushings will generally be elastomeric. The inserts, bosses, sleeves and/or bushings may be adapted to fit within indentations in the bipolar and monopolar plates and/or separators or to have ends that insert into the openings of the plates creating one or more channels. The dual polar, bipolar and monopolar plates can be formed or machined to contain matching indents for the bosses, inserts, sleeves and/or the bushings. Assembly of the stack of plates with the bosses, inserts, sleeves or bushings may create interference fits to effectively seal the channels. Alternatively, the bosses, inserts, sleeves and/or bushings may be melt bonded or adhesively bonded to the plates so as from a seal at the junction. Alternatively the bosses, inserts, sleeves and/or bushings may be coated in the inside with a coating which functions to seal the channel. As mentioned above, the posts can function to seal the channels. It is contemplated that a combination of these sealing solutions may be utilized in single channel or in different channels. The components of the stack of plates, including dual polar, monopolar plates and bipolar plates, preferably have the same shape and common edges. This facilitates sealing of the edges. Where separators are present they generally have a similar structure as the battery plates to accommodate the formation or creation of the transverse channels. The seal may be a thermoset polymer, such as an epoxy, polyurethane or acrylic polymer injected between the bolt and the transverse channel. One or more channels may be formed by inserts, bosses, sleeves and/or bushings bonded to, in openings, and/or integral with openings in one or more battery plates and/or one or more separators. One or more posts in one or more channels may apply sufficient pressure to hold inserts, holes, bosses, sleeves and/or bushings in place to form a sealed passage. The one or more channels may be formed from inserts and/or bosses bonded and/or integrated into one or more battery plates and one or more separators. One or more posts may be bonded to one or more inserts, bosses and/or substrates of the battery by an adhesive bond or by fusion of thermoplastic polymers or both. The inserts and/or bosses may be inserted one or more battery plates and/or separators by interference fit or bonded in place by an adhesive. Inserts and/or bosses in one or more separators may contain one or more vent holes that may allow communication between one or more electrochemical cells and one or more channels. One or more vent holes may allow transmission of gasses from one or more electrochemical cells to one or more channels and prevent the transmission of one or more liquids (i.e., an electrolyte) from one or more electrochemical cells to one or more channels.

The battery assembly may include a membrane. The membrane may function to seal about the edges of one or more end plates, plurality of battery plates, one or more separators, one or more transfer sheets, one or more channels, or any combination thereof. The membrane may be bonded to the edges of the one or more end plates, plurality of battery plates, and/or one or more separators by any means that seals the edges of the end plates, battery plates, and separators and isolates the one or more electrochemical cells. Exemplary bonding methods comprise adhesive bonding, melt bonding, vibration welding, RF welding, and microwave welding among others. The membrane may be a sheet of a polymeric material which material can seal the edges of the end plates, monopolar plates, and bipolar plates and can withstand exposure to the electrolyte and the conditions the battery is exposed to internally and externally. The same materials useful for the substrate of the battery plates may be utilized for the membrane. The membrane may be a thermoplastic polymer that can be melt bonded, vibration welded, or molded about the substrates of the monopolar and bipolar plates. The same thermoplastic polymer may be utilized for the monopolar and bipolar substrates and the membranes. Exemplary materials are polyethylene, polypropylene, ABS and, polyester, with ABS most preferred. The membranes may be the size of the side of the stacks to which they are bonded and the membranes are bonded to each side of the stack. The edges of the adjacent membranes may be sealed. The edges can be sealed using adhesives, melt bonding or a molding process. The membranes may comprise a single unitary sheet which is wrapped about the entire periphery of the stack. The membrane may have a leading edge and a trailing edge. The leading edge may be the first edge contact with the stack. The trailing edge may be the end, or last portion, of the membrane applied to the stack. The leading edge and the trailing edge may be bonded to the stack, to one another, or both to complete the seal of the membrane about the stack. This may be performed by use of an adhesive, by melt bonding or a molding process. In melt bonding the surface of the membrane and/or the edge of the stack are exposed to conditions at which the surface of one or both becomes molten and then the membrane and the edge of the stack are contacted while the surfaces are molten. The membrane and edge of the stack bond as the surface freezes forming a bond capable of sealing the components together. The membrane may be taken from a continuous sheet of the membrane material and cut to the desired length. The width of the membrane may match the height of the stacks of monopolar and bipolar plates. The membrane has sufficient thickness to seal the edges of the stack of monopolar and bipolar sheets to isolate the cells. The membrane may also function as a protective case surrounding the edges of the stack. The membrane may have a thickness of about 1 mm or greater, about 1.6 mm or greater or about 2 mm or greater. The membrane may have a thickness of about 5 mm or less, 4 mm or less or about 2.5 mm or less. When the membrane is bonded to the edge of the stack, any adhesive that can withstand exposure to the electrolyte and the conditions of operation of the cell may be used. Exemplary adhesives are plastic cements, epoxies, cyanoacrylate glues or acrylate resins. Alternatively, the membrane may be formed by molding a thermoplastic or thermoset material about a portion of, or all of the stack of battery plates. Any known molding method may be used including thermoforming, reaction injection molding, injection molding, roto molding, blow molding, compression molding and the like. The membrane may be formed by injection molding the membrane about a portion of or all of the stack of battery plates. Where the membrane is formed about a portion of the stack of the plates it may be formed about the edges of the battery plates or battery plates and the separator.

A sealed battery assembly may be placed in a case to protect the formed battery. Alternatively, the membrane in conjunction with a protective covering over the monopolar plates at the end of the stack may be used as a case for the battery. The monopolar plates may have an appropriate protective cover attached or bonded to the surface opposite the anode or cathode. The cover may be the same material as the membrane or a material that can be adhesively bonded or melt bonded to the membrane and can have a thickness within the range recited for the membranes. If affixed to the end of the plates the cover can be affixed with any mechanical attachment including the posts having overlapping portions. The case may be formed by molding a membrane about the stacks of battery plates and/or the opposite sides of the monopolar plates.

The battery assembly may include one or more posts. The one or more posts may function to hold the stack of components together in a fashion such that damage to components or breaking of the seal between the edges of the components of the stack is prevented, ensure uniform compression across the separator material, and ensure uniform thickness of the separator material. The one or more posts may have on each end an overlapping portion which engages the outside surface of opposing end plates, such as a sealing surface of each end plate. The overlapping portion may function to apply pressure on outside surfaces of opposing end plates in a manner so as to prevent damage to components or breaking of the seal between the edges of the components of the stack, and prevent bulging or other displacements of the stack during battery operation. The overlapping portion may be in contact with a sealing surface of an end plate. The stack may have a separate structural or protective end-piece over the monopolar endplate and the overlapping portion will be in contact in with the outside surface of the structural or protective end-piece. The overlapping portion can be any structure that in conjunction with the post prevents damage to components or breaking of the seal between the edges of the components of the stack. Exemplary overlapping portions include bolt heads, nuts, molded heads, brads, cotter pins, shaft collars and the like. The posts are of a length to pass through the entire stack but such length varies based on the desired capacity of the battery. The posts may exhibit a cross-section shape and size so as to fill a channel. The posts may have a cross-sectional size greater than the cross-sectional size of one or more channels so that the posts form an interference fit one or more of the channels. The number of posts is chosen to support the end plate and edges of the substrates to prevent leakage of electrolytes and gasses evolved during operation and to prevent the compressive forces arising during operation from damaging components and the seal for the individual electrochemical cells and to minimize edge-stress forces that exceed the fatigue strength of the seals. The plurality of posts may be present so as to spread out the compressive forces generated during operation. There may be fewer posts than channels where one or more of the channels are utilized as cooling channels or vent/fill channels. For example, there may be four channels with three channels having a post located therein and one channel may be used as a cooling, vent, and/or fill channel. The posts may comprise any material that performs the necessary functions. If the post is utilized to seal the channels, then the material used is selected to withstand the operating conditions of the cells will not corrode when exposed to the electrolyte and can withstand the temperatures and pressures generated during operation of the cells. Where the posts perform the sealing function, the posts may comprise a polymeric or ceramic material that can withstand the conditions recited. In this embodiment the material must be non-conductive to prevent shorting out of the cells. The posts may comprise a polymeric material such as a thermoset polymer or a thermoplastic material. The posts may comprise a thermoplastic material. Exemplary thermoplastic materials include ABS (acrylonitrile-butadiene-styrene copolymers), polypropylene, polyester, thermoplastic polyurethanes, polyolefins, compounded thermoplastic resins, polycarbonates and the like. ABS is most preferred. Where the channels are separately sealed the posts can comprise any material that has the structural integrity to perform the desired functions. Of the polymeric materials recited above, ceramics and metals may be utilized. Suitable metals may be steel, brass aluminum, copper and the like. The posts can comprise molded posts, threaded posts or posts with one or more end attachments. The posts may be bonded to parts of the stacks, for example the substrates, inserts or bosses in the channels, and the like. The bonds can be formed from adhesives or fusion of the polymeric materials, such as thermoplastic materials. The one or more openings may have threaded surfaces. If threaded, the one or more posts may also be threaded to engaged with the threaded openings. Posts may include a head or nut on one end opposing a nut, hole for a brad, cotter pin, the like, or a combination thereof. This is generally the case for non-molded posts. The posts may be constructed in such a way as to be a one way ratcheting device that allows shortening, but not lengthening. Such a post would be put in place, then as the stack is compressed, the post is shortened so that it maintains the pressure on the stack. The post in this embodiment may have ridges that facilitate the ratcheting so as to allow the posts to function as one part of a zip tie like structure. Matching nuts and/or washers may be used with posts so as to compress the plates they are adjacent to when in place. The nuts and/or washers go one way over the posts and ridges may be present to prevent the nuts and/or washers from moving the other direction along the posts. In use, the holes in the posts will have the appropriate brads, cotter pins, and the like to perform the recited function. If the post is molded is can be molded separately or in place. If molded in place, in situ, a seal may need to be present in the channel to hold the molten plastic in place. The seal may be formed by the interlocking inserts, a separate seal therein, or both. A nonconductive post which is threaded may be used and can provide the necessary seal. Alternatively, a pre-molded nonconductive polymeric post may be designed to form an interference fit in the channel in a manner so as seal the channels. The posts may be formed in place by molding, such as by injection molding.

The battery assembly may include one or more valves. The one or more valves may function to draw a vacuum from an interior of the battery assembly, fill the battery assembly with an electrolyte, and/or vent the battery assembly during operation. The one or more valves may include a pressure release valve, check valve, fill valve, pop valve, and the like, or any combination thereof. The one or more valves may be connected to and/or in communication with one or more channels formed by one or more openings of an end plate, battery plate, separator, or any combination thereof. The one or more valves may be in communication with a channel, such as a channel having a post there through or free of a post. The battery assembly may include one or more valves as described in US Patent Application Publication No. 2014/0349147, incorporated herein by reference in its entirety for all purposes. The assembly may contain pressure release valves for one or more of the cells to release pressure if the cell reaches a dangerous internal pressure. The pressure release valves are designed to prevent catastrophic failure in a manner which damages the system the battery is used with. Once a pressure release valve is released the battery is no longer functional. The assemblies disclosed may contain a single check valve which releases pressure from the entire assembly when or before a dangerous pressure is reached. Some exemplary suitable valves are disclosed in U.S. Pat. Nos. 8,357,469; 9,553,329; 9,685,677; 9,825,336; and US Patent Application Publication No.: 2018/0053926; incorporated herein by reference in their entirety for all purposes.

The battery assembly may include one or more terminals. The assembly may contain one or more pairs of conductive terminals, each pair connected to a positive and negative terminal. The one or more terminals may function to transmit the electrons generated in the electrochemical cells to a system that utilizes the generated electrons in the form of electricity. The terminals are adapted to connect each battery stack to a load, in essence a system that utilizes the electricity generated in the cell. The one or more terminals may pass through one or more end plates, one or more battery plates, a membrane, and/or a case. The one or more terminals may pass through a battery plate from an end plate to the outside or passing through the side of the case or membrane about the assembly essentially parallel to the plane of the end plates. The terminal matches the polarity of the anode or cathode of the monopolar plate, dual polar plate, bipolar plate, or a combination thereof. The terminals are in contact with the conductive conduits in the assemblies. The cathode of the monopolar plate and the cathodes of one or more of the bipolar plates with a cathode current collector may be connected to independent positive terminals. The anode of the monopolar plate and the anodes of one or more of the bipolar plates with an anode current collector may be connected to independent negative terminals. The cathode current collectors may be connected and the anode current collectors may be connected in parallel. The individual terminals may be covered in a membrane leaving only a single connected positive and a single connected negative terminal exposed. Some exemplary suitable terminal assemblies are disclosed in U.S. Pat. Nos. 8,357,469; 9,553,329; 9,685,677; 9,825,336; and US Patent Application Publication No.: 2018/0053926; incorporated herein by reference in their entirety for all purposes.

The battery assembly may include one or more conductive conduits. The conductive conduits may function to transmit electrons from the current collectors in contact with the cathodes to one or more positive terminals. A typical bipolar battery flows electrons from cell to cell through the substrate. Either the substrate at least partially comprises a conductive material or comprises conductive pathways through the substrate. When the circuit is closed that contains the cells electrons flow from cell to cell through the substrate to the positive terminal. It is contemplated that the assemblies may flow electrons through the substrates and cell, through a current collector to a current conductor or both. In the batteries disclosed herein having two or more stacks, each stack has a current conductor and/or a conductive conduit contacting the current collectors in contact with the anodes with a negative terminal and a current conductor and/or a conductive conduit contacting the current collectors in contact with the cathodes with a positive terminal. The conductive conduits from the two or more stacks may be arranged in parallel or in series. Parallel circuits comprise two or more circuits that are not connected to one another. Series circuits comprise two or more circuits that are arranged such that electrons flow through the circuits sequentially. When the conductive conduits are arranged in a series configuration, the battery may have only one negative terminal and one positive terminal. When the conductive conduits are arranged in a parallel manner, the battery may have single positive and negative terminals in which each circuit connects with each of the negative or positive terminals. Alternatively, each circuit may have separate negative and positive terminals. The terminals may be connected to the load which typically utilizes the electricity stored in the battery. Each of the current conductors and/or current conduits in contact with current collectors in contact with cathodes in a parallel arrangement may be contacted with separate positive terminals. Each of the current conductors and/or current conduits in contact with current collectors in contact with anodes in a parallel arrangement may be contacted with separate negative terminals.

The sealed stack may be placed in a case to protect the formed battery. Alternatively, the membrane in conjunction with a protective covering over the monopolar plates at the end of the stack may be used as a case for the battery. The monopolar plates may have an appropriate protective cover attached or bonded to the surface opposite the anode or cathode. The cover may be the same material as the membrane or a material that can be adhesively bonded or melt bonded to the membrane and can have a thickness within the range recited for the membranes. If affixed to the end of the plates the cover can be affixed with any mechanical attachment including the posts having overlapping portions. The case may be formed by molding a membrane about the stacks of battery plates and/or the opposite sides of the monopolar plates.

### Illustrative Embodiments

The following descriptions of the Figures are provided to illustrate the teachings herein, but are not intended to limit the scope thereof. One or more features illustrated in one figure may be combined with one or more features of another figure.

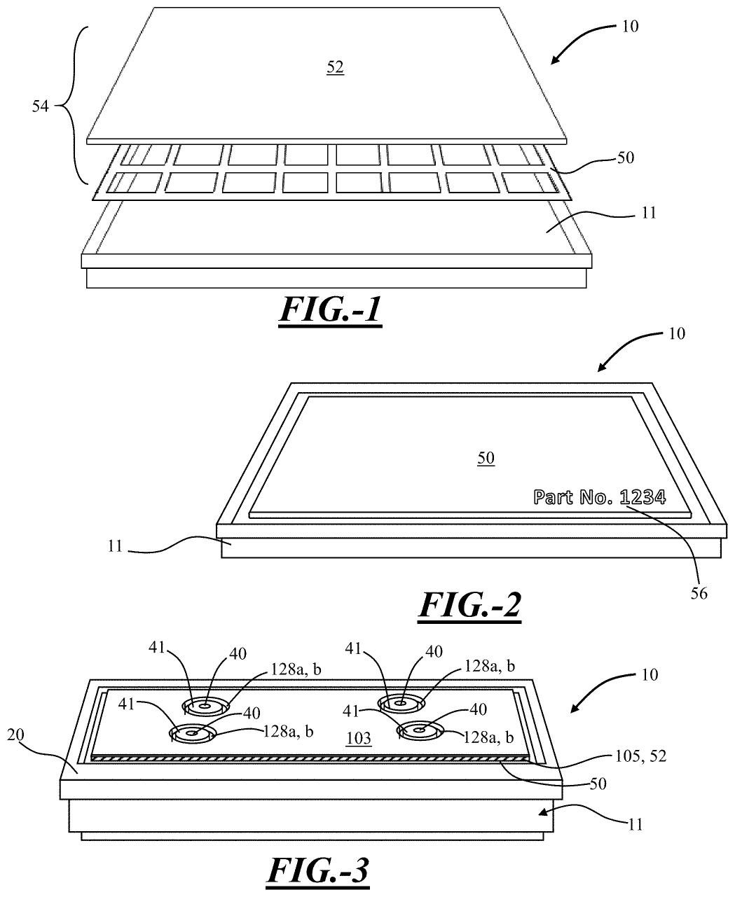

FIG. 1 illustrates an exploded view of a battery plate 10. The battery plate 10 includes a substrate 11. Located on the substrate 11 is a current collector 50. The current collector 50 is in the form of a grid. Disposed on the current collector 50 is an active material 52. The current collector 50 and active material 52 together form an electrode 54. The electrode 54 may be in the form of an anode 12 or cathode 13. The battery plate 10 may have a single electrode 54 disposed on one surface of the substrate 11 (e.g, monopolar), or may include opposing electrodes 54 disposed on opposing surfaces of the substrate 11 (e.g., bipolar or dual polar).

FIG. 2 illustrates a substrate 11 and a current collector 50 of a battery plate 10. The current collector 50 is in the form of a foil. The current collector 50 includes identification information 56 thereon. The identification information 56 is etched into the current collector 50 via a laser.

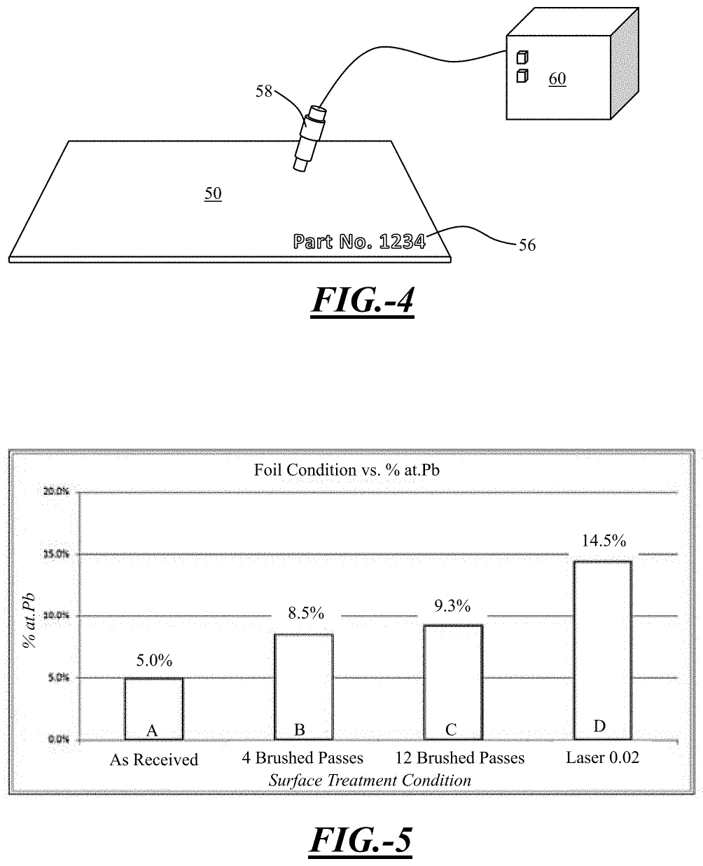

FIG. 3 shows a battery plate 10. The battery plate 10 includes a substrate 11. The substrate 11 includes a frame 20 about its periphery. The frame 20 projects from the substrate 11. The substrate 11 includes inserts 41 projecting therefrom. The inserts 41 include openings 40. The inserts 41 project through voids 128a, b. The voids 128a, b are formed in the paste 105 and transfer sheet 103. The paste 105 is the active material 52. Located between the active material 52 and the substrate 11 is the current collector 50. The inserts 41 project beyond the paste 105 and the transfer sheet 103.

FIG. 4 illustrates a laser 58. The laser 58 is connected to a power source 60. The laser 58 is capable of removing oxidation from a surface of a current collector 50. The laser 58 is also capable of etching identification information 56 into the current collector 50.

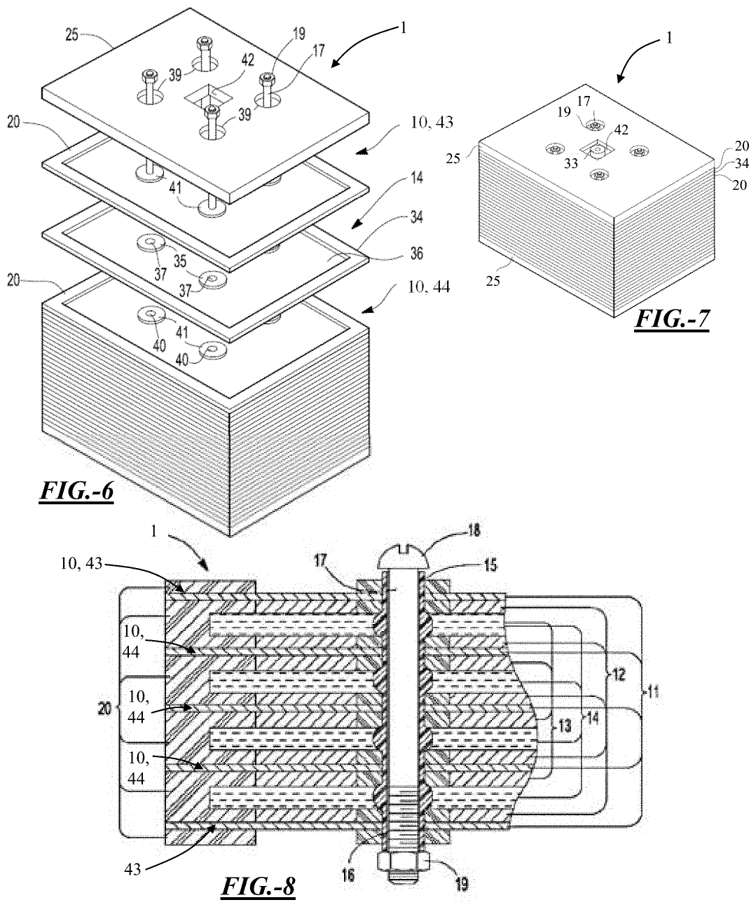

FIGS. 6 and 7 illustrate a stack of battery plates 10 and separators 14 which form a battery assembly 1. FIG. 6 illustrates a partially exploded view of the battery assembly 1 while FIG. 7 illustrates a perspective view of the battery assembly 1. Shown is an end plate 25 having a terminal hole 42 and holes 39 for posts 17. The posts 17 are shown in the form of bolts having nuts 19. The posts 17 pass through the entire stack of battery plates 10. Adjacent to the end plate 25 is a battery plate 10 which is a monopolar plate 43 having a frame 20 with a raised edge. The monopolar plate 43 has raised inserts 41 that surround holes 40. Adjacent to the monopolar plate 43 is a separator 14. The separator 14 has a frame 34 about its periphery. The separator 14 includes an absorbent glass mat 36 comprising the central portion within the frame 34. The separator 14 includes molded inserts 35 surrounding molded insert holes 37. Adjacent to the separator 14 is a bipolar plate 44. The bipolar plate 44 includes a frame 20 about its periphery. The frame 20 is a raised surface. The bipolar plate 44 includes raised inserts. The raised inserts 41 form raised insert holes 40. The raised inserts 41 of battery plates 10 align with adjacent molded inserts 35 of separators 14. The holes 40 of battery plates 10 align with holes 37 of adjacent separators 14. The aligned inserts 41, 35 and aligned holes 40, 37 form a transverse channel 16. A post 17 resides within a transverse channel 16. FIG. 7 shows the stack of battery plates 10 and separators 14 of the battery assembly 1. Shown are end plates 25 at opposing ends, battery plate substrate frames 20, separator frames 34, posts 17, and nuts 19 about the posts 17. A terminal hole 42 in the endplate 25 has a battery terminal 33 located therein.

FIG. 8 shows a partial side view of a stack of battery plates 10 which form a battery assembly 1. The battery plates 10 include monopolar plates 43 at opposing ends of the stack of battery plates 10. In between the opposing monopolar plates 43 is a plurality of bipolar plates 44. Each of the battery plates 10 include a substrate 11. Adjacent to each substrate 11 of the bipolar plates 44 are anodes 12 and cathodes 13. Disposed between each pair of anodes 12 and cathodes 13 is a separator 14. The separator 14 is shown as an absorbent glass mat having a liquid electrolyte absorbed therein. Each pair of anodes 12 and cathodes 13 with the electrolyte therebetween form an electrochemical cell. Also shown is a transverse channel 16. A channel seal 15 is disposed within the transverse channel 16. The channel seal 15 is formed as a rubber tube. The use of aligned and interlocked inserts 41, 35 (such as shown in FIG. 6) may allow for avoiding the use of a separate seal and form the channel seal 15. Located inside the channel seal 15 is a post 17. The post 17 is in the form of a threaded bolt. At the end of the post 17 are overlapping portions in the form of a bolt head 18 and nut 19. About the edge of the substrates 11 of both the monopolar plates 43 and bipolar plates 44 are frames 20.

### Examples

The following examples are provided to illustrate the teachings of the present disclosure, but are not intended to limit the scope thereof.

Four current collectors for battery plates are prepared based on the teachings herein. The four exemplary current collectors are referred to as Sample A, Sample B, Sample C, and Sample D. Each current collector from Sample A, B, C, and D is prepared as a lead foil. The lead foil has a thickness of 150 microns. The lead foil has a 239-mm width and a 248.25-mm length. The elemental lead at the surface of each Sample is measured by electron spectroscopy for chemical analysis (ESCA).

Sample A: The current collector does not receive any surface treatment to remove oxidation or other contaminants. Through the ESCA, it is found that the current collector has 5% of elemental lead exposed at the foil surface.

Sample B: The current collector receives a wire brushing treatment. The wire brushing treatment consists of running the foil under rotating brushes as 4 consecutive passes. The wire brush is an abrasive nylon from Brush Research Manufacturing with Part Number CY4180SCF. The wire brush rotates at a speed of 1,725 RPM with a linear rate of about 12 in/sec (304.8 mm/sec) to pass over the foil. Each pass over the foil takes about 10 seconds and the 4 passes take about 40 seconds to complete. Through ESCA, it is found that the current collector has 8.5% of elemental lead exposed at the foil surface.

Sample C: The current collector receives a wire brushing treatment. The wire brushing treatment consists of running the foil under rotating brushes as 12 consecutive passes. The wire brush is an abrasive nylon from Brush Research Manufacturing with Part Number CY4180SCF. The wire brush rotates at a speed of 1,725 RPM with a linear rate of about 12 in/sec (304.8 mm/sec) to pass over the foil. Each pass over the foil takes about 10 seconds and the 8 passes take about 80 seconds to complete. Through ESCA, it is found that the current collector has 9.3% of elemental lead exposed at the foil surface.

Sample D: The current collector receives a laser treatment. The laser treatment consists of running the foil through a laser ablation process with a single pass. The laser is a 100-watt fiber laser from IPG Photonics. The laser has a Galvo scan head which uses 0.02 percent of power. The head has a spot size of about 70 microns which travels at a linear rate of about 13 m/second. A single pass over the foil with the laser takes about 44 seconds. Through ESCA, it is found that the current collector has 14.5% of elemental lead exposed at the foil surface.

FIG. 5 illustrates the amount of elemental lead at the foil surface of samples A, B, C, and D prepared as disclosed above. As can be seen, Sample D has 2.9 times greater elemental lead exposed at the surface as compared to Sample A. Sample D has 1.7 times greater elemental lead exposed at the surface as compared to Sample B. Sample D has about 1.6 times greater elemental lead exposed at the surface as compared to Sample C.

### REFERENCE NUMBER LISTING

1 Battery assembly
10 Battery plate
11 Substrate of battery plate
12 Anode
13 Cathode
14 Separator
15 Channel seal
16 Transverse channel
17 Post
18 Bolt head
19 Nut
20 Frame of battery plate
25 End plate
33 Battery terminal
34 Frame of separator
35 Insert of separator
36 Absorbent glass mat
37 Insert hole in separator
39 Hole
40 Insert hole of battery plate
41 Insert of battery plate
42 Terminal hole
43 Monopolar plate
44 Bipolar plate
50 Current Collector
52 Active Material
54 Electrode
56 Identification information
58 Laser
60 Power source

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The terms “about”, “generally”, or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “about”, “generally”, or “substantially” to describe linear measurements, percentages, or ratios may mean about +/−10% or less, about +/−5% or less, or even about +/−1% or less. The terms “about”, “generally” or “substantially” to describe linear measurements, percentages, or ratios may mean about +/−0.01% or greater, about +/−0.1% or greater, or even about +/−0.5% or greater.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

What is claimed is:

1. A method for producing a battery plate comprising:
a) adhering a current collector to one or more surfaces of a substrate of the battery plate;
b) ablating a pasting surface of the current collector with an energy source which is a non-contact energy source;
c) pasting an active material onto the pasting surface of the current collector; and
d) curing, drying, or both the active material on the current collector to form an electrode as part of the battery plate.

2. The method according to claim 1, wherein the energy source utilizes energy in a form of a laser, infrared energy, microwave energy, radiofrequency, plasma, or any combination thereof.

3. The method according to claim 1, wherein the energy source is in a form of one or more lasers which perform the ablating with a pulsed laser, a continuous wave laser, or both.

4. The method according to claim 2, wherein the pasting surface of the current collector is opposite a substrate surface of the current collector, and the substrate surface faces and is in contact with the substrate.

5. The method according to claim 2, wherein the ablating removes about 1 micron or greater of material on the pasting surface.

6. The method according to claim 5, wherein the ablating removes about 3 microns or greater to about 50 microns or less of material on the pasting surface.

7. The method according to claim 2, wherein the ablating removes about 0.05% or greater to about 30% or less of an overall thickness of the current collector before the ablating.

8. The method according to claim 2, wherein the ablating increases a surface area of the current collector by 10% or more.

9. The method according to claim 2, wherein the adhering occurs before or after the ablating.

10. The method of claim 2, wherein the current collector is comprised of one or more metals.

11. The method of claim 10, wherein the one or more metals include: silver, tin, copper, aluminum, lead, alloys thereof, or any combination thereof.

12. The method of claim 11 wherein the one or more metals includes the lead or a lead alloy.

13. The method according to claim 10, wherein the current collector is in the form of a sheet, a foil, a grid, a screen, a mesh, or any combination thereof.

14. The method according to claim 13, wherein the active material is a positive active material or a negative active material

15. The method according to claim 14, wherein the active material is the positive active material, and the current collector with the positive active material forms a cathode.

16. The method according to claim 14, wherein the active material is the negative active material, and the current collector with the negative active material forms an anode.

17. The method according to claim 2, wherein the ablating leaves one or more patterns on the pasting surface, a substrate surface opposite the pasting surface, or both of the current collector.

18. The method according to claim 17, wherein the one or more patterns includes one or more identifiers.

19. The method according to claim 18, wherein the one or more identifiers include one or more part numbers, corporate identifiers, manufacturing sequence identifiers, or a combination thereof.

20. A battery plate formed by the method of claim 1, wherein the battery plate is a grid, a monopolar plate, a bipolar plate, a dual polar plate, or a combination thereof.
